(19) United States
(12) Patent Application Publication
(10) Pub. No.: US 2006/0289123 A1
(43) Pub. Date: Dec. 28, 2006

(54) Lightweight window treatment

(76) Inventors: John A. Corey, Melrose, NY (US); Richard D. Watkins, Lake Luzerne, NY (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/471,080

(22) Filed: Jun. 20, 2006

Related U.S. Application Data
(60) Provisional application No. 60/692,738, filed on Jun. 22, 2005.

(51) Int. Cl. E06B 9/26

(52) U.S. Cl. 160/166.1

(57) ABSTRACT

A window treatment is described that includes at least one vane comprising a tube. The tube includes an upper surface and a lower surface. The tube causes the upper surface to be spaced apart from the lower surface and the tube may also be disposed inside a sleeve. The vanes may be assembled to form a shutter, a Venetian blind, a vertical blind or the like.

### CROSS-REFERENCE To RELATED APPLICATIONS

This application claims the benefit of U.S. Provisional Application Ser. No. 60/692,738 filed Jun. 22, 2006, which is hereby incorporated by reference in its entirety.

### TECHNICAL FIELD

The embodiments described herein are generally directed to a window treatment.

### BACKGROUND

In many window or see-through door applications, it is desirable to control the amount of light admitted through the window or a see-through door. For instance on bright sunny days in warm climates, the sun is too strong (and too hot) for comfortably working in offices, as well as being damaging to interior furnishings that may fade or become brittle. Typically, blinds are fitted, consisting of multiple slats of opaque material that can be rotated, in a coordinated manner, to block all or part of the light. A popular but costly form of window treatment for light control and aesthetic enhancement is an interior shutter as shown in FIG. 1.

The interior shutter 20 typically consists of a frame 21 having two vertical members 22 and two horizontal members 24. Each vertical member 22 is attached to an end of a horizontal member 24 as shown in FIG. 1. The frame 20 is typically mounted by hinges to the side of the window and filled with a plurality of vanes 26 in a horizontal array. Each vane 26 is adapted for coordinated rotation about a pin 28 by a control bar 30. The rotation of the vanes 26 moves the vanes 26 from an overlapping orientation that substantially blocks all light and the ability to view through the window to a fully-open orientation where the thinnest sections of the vanes are aligned with the line of sight of a user, admitting maximum light and permitting maximum visibility through the interior shutter.

Traditionally, both the frame 21 and the vanes 26 are made from a wood material or wood-composite material. In recent years, a number of synthetic alternatives have been offered that mimic the look and feel of wood shutters. Shutters are especially popular in southern climates, where their sun-blocking and thermal mass are desired and the lack of effective insulation against heat transport by conduction, convection, or air circulation is not a severe penalty. In contrast, users in northern climates have preferred more blanket-like products such as insulated drapes or cellular fabric shades, which provide better air flow control, higher insulation of convection and conduction, and provide varying degrees of opacity to allow privacy without complete darkness. Examples of various cellular products are shown in the Symphony™ line by Comfortex Corporation and Duette™ line by HunterDouglas.

Users outside the southern regions desire the appearance of shutters in their homes, but find the darkening too severe, the winter heat loss too great, and often, the weight of the shutter too heavy on the light-framed walls. Further, the sensitivity to changes in humidity of traditional wood or wood-composite shutter shortens their useful life in some climates by causing warping and peeling, further reducing their utility and suitability for a larger range of users including those in cooler climates.

### SUMMARY

A lightweight window treatment includes at least one vane comprising a tube. The tube includes an upper surface and a lower surface. The tube causes the upper surface to be spaced apart from the lower surface and the tube may also be disposed inside a sleeve. The vanes may be assembled into a window treatment in the form of a shutter, a Venetian blind, or the like.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of a prior art shutter;

FIG. 2 is a perspective view a vane of a window treatment according to a first embodiment of a window treatment;

FIG. 3A is a cross-sectional view of a sleeve having two free edges;

FIG. 3B is a cross-sectional view of a tube and the sleeve of FIG. 3A having the tube disposed inside the sleeve;

FIG. 3C is a cross-sectional view of a tube and the sleeve of FIG. 3A having an insert disposed inside a tube;

FIG. 4A is a cross-sectional view of a sleeve having one free edge;

FIG. 4B is a cross-sectional view of a tube and the sleeve of FIG. 4A having the tube disposed inside the sleeve;

FIG. 4C is a cross-sectional view of a tube and the sleeve of FIG. 4A having an insert disposed inside the tube;

FIG. 5 is an exploded perspective view of a shutter according to a second embodiment of a window treatment;

FIG. 6 is a cross-sectional view of a Venetian blind showing a rivet holding the vane in a predetermined location along a ladder rung cord in an open orientation according to a third embodiment of a window treatment;

FIG. 7 is a cross-sectional view of the Venetian blind of FIG. 6 in a closed orientation;

FIG. 8 is a perspective view the vane as shown in FIG. 2 further including a sleeve;

FIG. 9 is a side elevational view of a modified end cap showing a front extension for opening and closing the vane; and

FIG. 10 is a side elevational view of the end cap shown in FIG. 2.

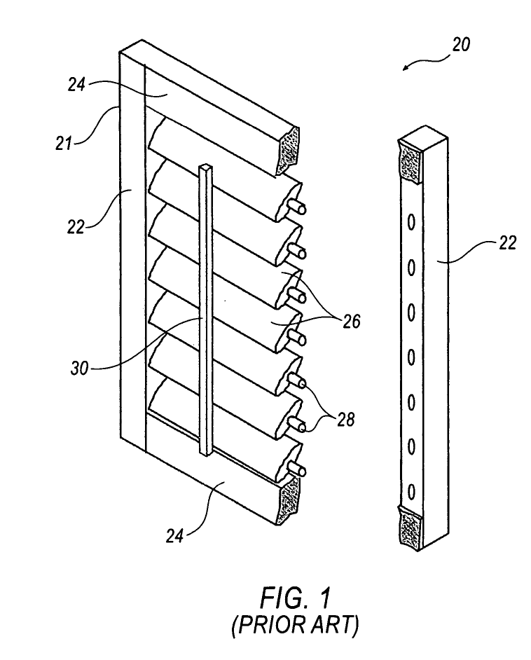

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

Referring now to FIGS. 2-5, an embodiment of a window treatment 50 will now be described. For the purposes of this disclosure, the window treatment 50 may be used for other purposes, such as doors or to otherwise furnish the interior of a dwelling.

The window treatment 50 includes a plurality of vanes 52, each having a tube 54 defining an upper surface 56, a lower surface 58, and ends 60, 62 along a longitudinal axis A-A. Depending upon the translucently and color of its materials, the tube 54 forms a light controlling element. The color of the tube 54 may vary with a user's requirement for light translucency and may be formed from any lightweight material including a plastic and a fabric. The tube 54 may be molded in colors or degree of translucence directly or for mimicking conventional wood vanes.

As best shown in FIGS. 2, 3B, and 4B, an embodiment of the tube 54 includes a generally flattened ellipse in a final form. The tube 54 may be made by extrusion of thermoplastics either initially extruded in its final form, or as a generally circular cross-section, later flattened by post-forming. However, the tube 54 may be formed from any non-woven material. Woven materials consists of a fabric. In one embodiment, the tube 54 is formed from extruded plastic having a clear or a milky white translucent property.

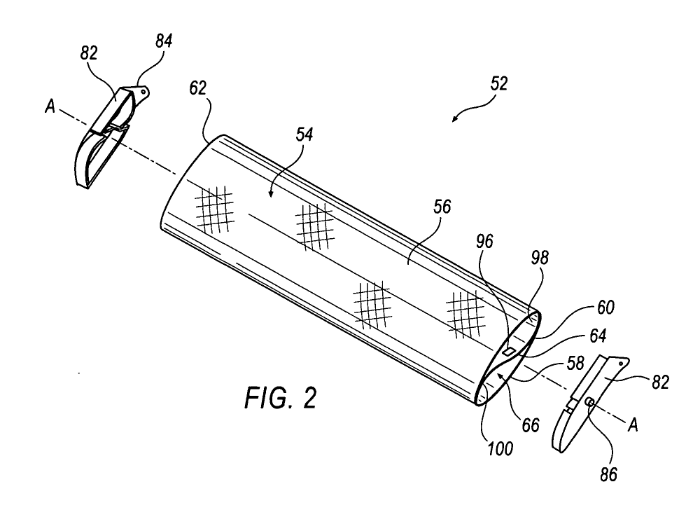

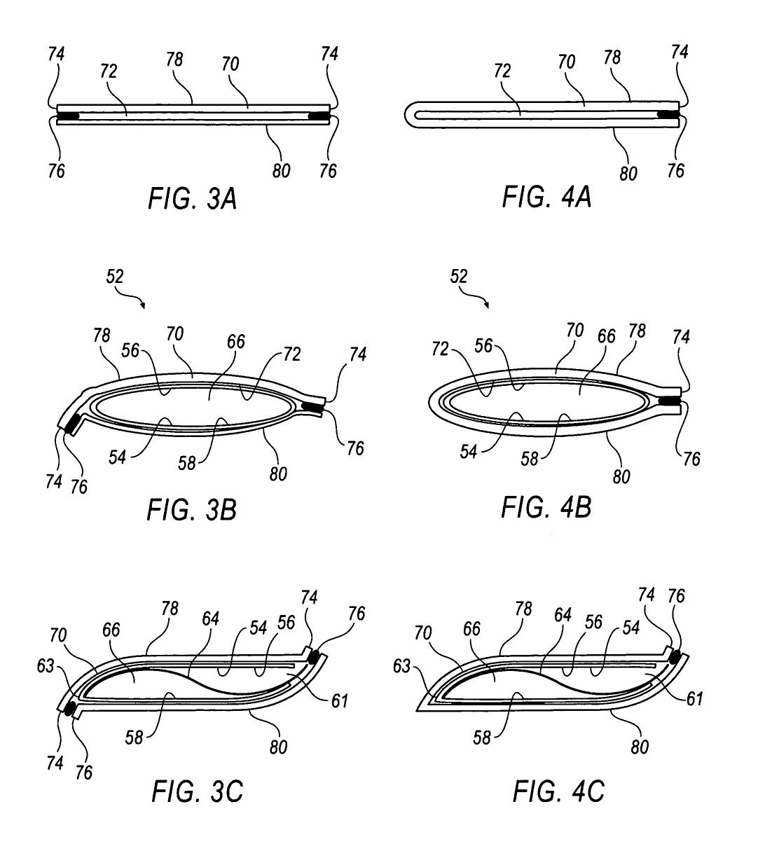

In another embodiment as shown in FIGS. 3C and 4C, the tube 54 is formed of a generally U-shaped single strip having one free edge 61 and a bend 63. In yet another embodiment, the tube 54 is formed from two strips having one or two free edges (not shown) joined together by gluing, welding, stitching, or other attaching method to forming at least one joint (not shown). Having two strips allows the user to select two different colored materials for the tube 54 permitting various desired light effects. For instance, the upper surface 56 may be formed with a soft colored plastic and the lower surface 58 may be formed with stiffer plastic for structural purposes.

An insert 64 may be received within an interior 66 of the tube 54 causing the upper surface 56 to be spaced apart from the lower surface 58. The insert maintains the straightness and torsional stiffness of the tube 54. For illustrative purposes, the insert 64 is shown formed into an “S” cross-sectional shape; however, other cross-sectional shapes may be used including a “V” and “C” shape. The insert 64 may be any suitable non-flat cross-sectional shape that maintains the straightness and torsional stiffness of the tube 54. The insert 64 may have generally the same overall length as the tube 54.

When the tube 54 includes a sleeve 70 as shown in FIGS. 3A-4C, the tube 54 is received within a sleeve interior surface 72 causing the interior surface 72 to be spaced apart. The sleeve 70 provides less stringent and less costly surface quality on the vane 52. In one embodiment as shown in FIGS. 3A-3C, the sleeve 70 may be formed by two strips of fabric joined together along free edges 74. The sleeve 70 is joined by sewing, gluing, welding, taping, or the like forming joints 76 that hold an upper sleeve surface 78 to a lower sleeve surface 80. The upper sleeve surface 78 and the lower sleeve surface 80 may include different colors, textures, or material as desired on the two surfaces 78, 80 and thereby on the faces of the finished vane 52. The sleeve 70 may have different materials with various stiffness properties for the two surfaces 78, 80 for providing different apparent contours in a cross-section. The material with a higher stiffness property will provide greater rigidity for the contour and give the vane 52 a different shape. Moreover, the stiffness of the material provides support for the vane 52 in the longitudinal length along axis A-A as shown in FIG. 2. The tube 54 may be preserved in a desired position in the sleeve 70 by using a patch (not shown), an adhesive such as double sided tape, or the like between the tube 54 and the sleeve 70. In another embodiment as shown in FIGS. 4A-4C, the sleeve 70 may be formed from a single strip of fabric, folded over and joined along the free edge 74.

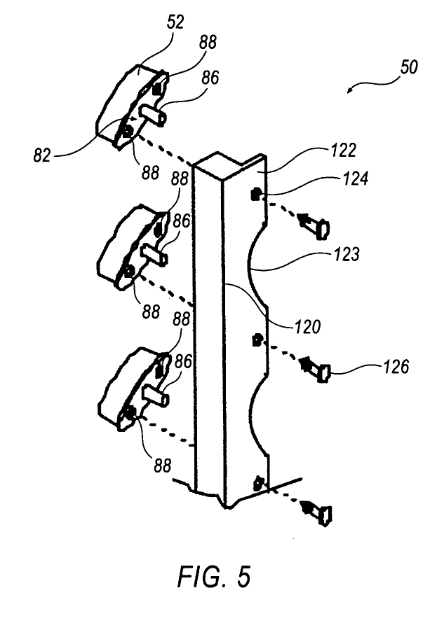

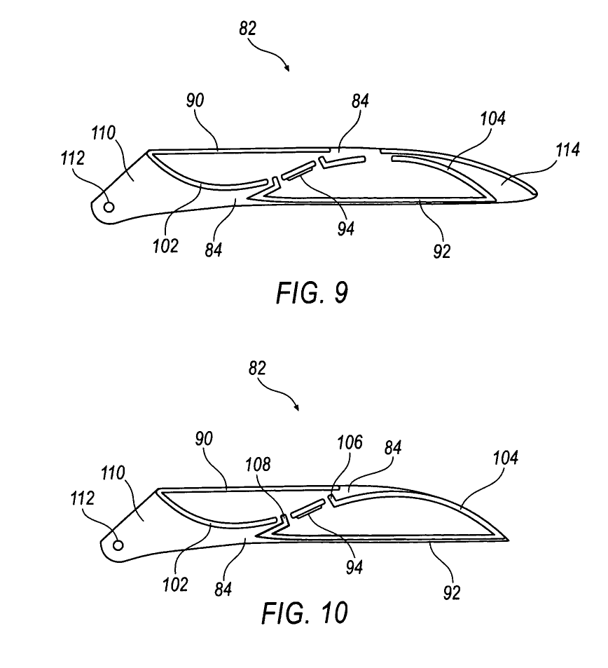

In one embodiment, the vane 52 includes at least one end cap 82 as shown in FIGS. 2, 8, 9 and 10. Each end cap 82 is molded of a compatible polymer shaped to engage the ends 60, 62 of the tube 54 to a predetermined depth stopping at a cap flange 84. As shown in FIG. 5, the end cap 82 may include an integral pin 86 and a hole 88, which can be used for coordinating vane 52 rotation as further described below. In one embodiment as shown in FIGS. 9 and 10 the end cap is adapted to receive the insert 64 in the form of an “S” cross-sectional shape. The end cap 82 includes an upper wall 90 and a lower wall 92. The upper wall 90, when inserted into the tube 54, is adjacent the upper surface 56 and the lower wall 92 is adjacent the lower surface 58 of the tube 54. The end 60 of the tube 54 abuts the cap flange 84 in a secured orientation. As shown in FIGS. 2, 9 and 10, the end cap 82 is further held in place by having a clip 94 of the end cap 82 engage a slot 96 of the insert 64 located proximate end 60 and between an upper insert surface 98 and a lower insert surface 100. The “S” shaped insert 64 engages the end cap 82 by having the upper insert surface 98 engage a lower portion 102 of the upper wall 90 and having the lower insert surface 100 engage the upper portion 104 of the lower wall 92. The upper portion 104 of the lower wall 92 includes two legs 106, 108 having a generally triangular shape with a base of the legs 106, 108 being adjacent the cap flange 84. Each leg 106, 108 forms a ramp having a maximum length at a first end adjacent the cap flange 84 and a minimum length at a second end opposite the first end.

During assembly, the legs 106, 108 work in conjunction with the clip 94 in retaining the end cap 82 in the interior 66 of the tube 54 by having the clip 94 engage the slot 96 of the inset 64 as discussed above. When the end cap 82 is inserted into an end 60 of the tube 54, the “S” shaped insert 64 slides between the upper wall 90 and lower wall 92 in the manner described above. The legs 106, 108 help facilitate the locking of the end cap 82 by biasing the insert 64 against the clip 94 until the clip 94 engages the slot 96 of the insert 64.

Referring to FIGS. 9 and 10, the end cap 82 further includes a rear extension 110 having a hole 112. The rear extension 110 facilitates the simultaneous movement of the vanes 52 as further described below. A bar (not shown) is disposed between the rear extensions 110 of the vanes 52 and is connected to the holes 112 by a pin (not shown). The bar fixes the rear extensions 110 together so that each vane 52 is in pivotal communication with the bar. A front extension 114 is adapted to provide a gripable edge or flange for actuating the vanes 52 between a closed and an open orientation when the front extension 114 is moved in either an upwardly or downwardly direction. The movement of the front extension 114 moves the vanes 52 (because of their interconnecting bar) from an overlapping orientation that substantially blocks all light and the ability to view through the window to a fully-open orientation where the thinnest sections of the vanes 52 are aligned with the line of sight of a user, admitting maximum light and permitting maximum visibility through the vanes 52.

In operation, when the user applies a force to the front extension 114 in an upwardly direction, the vane 52 will pivot around the pin 86 moving the rear extension 110 in a downwardly direction. The bar connecting each rear extension 110 of each vane 52 will simultaneously move each vane 52 in generally the same angle of rotation about each pin 86.

Another embodiment of a vane actuating member is shown in FIG. 5. A vane actuating member in the form of a control bar 120 is shown in mechanical communication with the end caps 82. The control bar 120 includes a projection 122, depression 123, and bar holes 124. The control bar 120 engages is in mechanical communication with vanes 52 by having a pin-clip 126 disposed in bar hole 124 and hole 88. The pin clip 126 is pushed through bar hole 124 to engage the end cap 82 at the hole 88. The control bar 120 connects and coordinates the rotation of the vanes 52 when moved in the upwardly and downwardly direction as described above. Depression 123 of the control bar 120 provides a clearance from the vane 52 when the control bar 120 is in a closed orientation.

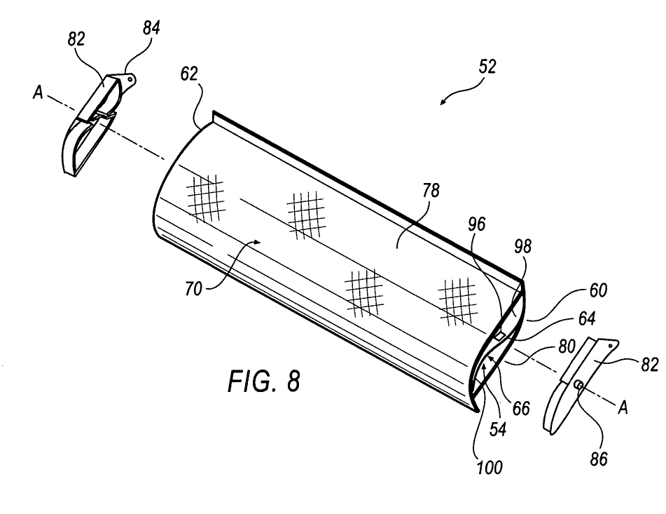

As will be clear to one skilled in the art, the exemplary embodiments described herein have the particular advantages of simplicity and esthetic value as well as being low weight, low cost, insensitive to weather and moisture, and providing variable opacity. Some other exemplary variants may include having painted or coated tubes 54 as shown in FIG. 8, bare tubes 54, and sleeved tubes 54. Another embodiment of an end cap (not shown) may be formed from folded-over portions of the tube 54. The vanes 52 may be disposed in a vertical direction. The actuating member may include chains, rack-and-pinion systems as alternatives to various control bars 120. The inserts 64 and tubes 54 may include selectable opacity or other optical properties, for example, polarization and photo-sensitivity that may be used to give additional or alternative light-controlling properties to the vanes 52. The sleeve 70 may be a sheet, directly wrapped and adhered to the tube 54, or a shrink-film sleeve 70 having printed patterns or logos.

The embodiments described are conducive to being made from commonly-used plastics. They are readily assembled without woodworking tools or dusty scrap typical of conventional vanes 26, and may be configured with a plurality of the same key components to economically accommodate different size windows and shutter panels.

The light weight of the hollow vanes 52 greatly reduces the total weight of a shutter compared to conventional construction. The lower weight reduces the need for heavy frames, and the total weight reduction enables the application to more windows, including those in walls and partitions insufficient to support the load of conventional shutters.

The hollow vanes 52 provide a thermal barrier when closed, by trapping a dead-air space in each, adding to the thermal insulation value of the shutter. When configured with a two-strip sleeve, the projecting sleeve joints 74 as shown in FIG. 7 may further provided gasket-like contact sealing between adjacent vanes 52 for further control of air movement.

The hollow vanes 52, if translucent, admit a wide range of add-in light control features, such as light-reactive films, polarizers, and shadow-pattern masks.

The sleeve 70 allows for a uniform white, reflective outward-facing surface and an attractive fabric inward-facing surface. The sleeve 70 may be changed at a later date to update the appearance of the shutter without total product replacement.

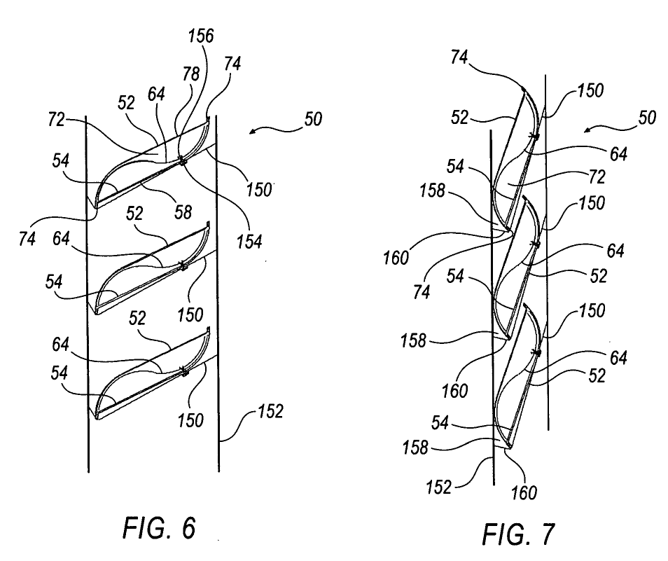

FIGS. 6 and 7 show an alternate embodiment of a window treatment 50 having a plurality of vanes 52 forming a Venetian blind. Each vane 52 is disposed on a ladder rung cord 150 and between two vertical ladders 152. A rivet 154 secures the lower surface 58 of the tube 54 along the ladder rung cord 150 at a predetermined position creating a “hanging” condition when the vanes 52 are in a closed orientation. One embodiment of the rivet 154 includes a fork headed rivet having a tip 156 that holds the tube 54 in place. The “hanging” condition results from the vane 52 hanging on the ladder rung cord 150 so that the vane 52 generally does not rest in a pocket 158 of the ladder rung cord 150. The “hanging” condition allows the front of the ladder rung cord 150 to experience little to no distortion from the weight of the vane 52. The generally right angle shape 160 of the pocket 158 permits each vane 52 to exhibit the relatively similar angle of rotation as the vanes 52 above. Otherwise, without the rivet 154, the vanes 52 experience a condition that provides more distortion at the pocket 158 and the vanes 52 become progressively less in the lower portions of the window treatment 50.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiments disclosed as the best modes contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A window treatment comprising:
a plurality of vanes, at least one vane includes a sleeve having an upper sleeve surface and a lower sleeve surface; and
a tube having an upper tube layer and a lower tube layer received within an interior of said sleeve causing said upper sleeve surface to be spaced apart from said lower sleeve surface.

2. The window treatment of claim 1, further comprising an insert received between said upper tube layer and said lower tube layer.

3. The window treatment of claim 1, wherein said sleeve is formed from at least two different materials of differing stiffnesses.

4. The window treatment of claim 1, wherein said vane includes an end cap at each end.

5. The window treatment of claim 2, wherein said vane includes an end cap at each end adapted to engage said insert.

6. The window treatment of claim 5, wherein said end cap includes a pin adapted to rotate said vane about a vane longitudinal axis.

7. The window treatment of claim 1, wherein said tube and said insert are formed with a plastic material.

8. The window treatment of claim 2, wherein said insert is generally in a shape of an S.

9. A window treatment comprising:
a plurality of vanes, at least one vane includes a tube having an upper surface and a lower surface;
an insert received within an interior of said tube causing said upper surface to be spaced apart from said lower surface; and
an end cap disposed at an end of said vane.

10. The window shutter of claim 9, further comprising a sleeve having an upper sleeve surface and a lower sleeve surface, said sleeve being disposed around said tube.

11. The window treatment of claim 10, wherein said sleeve is formed from at least two different materials of differing stiffnesses.

12. The window treatment of claim 9, wherein said vane includes a second end cap at a second end.

13. The window treatment of claim 9, wherein said window treatment is a shutter.

14. The window treatment of claim 9, wherein said window treatment is a Venetian blind.

15. The window treatment of claim 9, wherein said window treatment is a vertical blind.

16. The window treatment of claim 9, wherein said end cap is adapted to engage said insert.

17. The window treatment of claim 9, wherein said end cap includes a pin adapted to permit said vane to pivot about a vane longitudinal axis.

18. The window treatment of claim 9, wherein said insert is formed with a plastic material.

19. The window treatment of claim 9, wherein said insert is generally in a shape of an S.

20. The window treatment of claim 9, wherein said vane includes an end cap having a closure extension operable to pivot said vane from an open to a closed orientation by a user.

21. A Venetian blind comprising:
a plurality of vanes, at least one vane includes a tube having an upper surface and a lower surface;
a ladder cord having a rung cord supporting a portion of said vane;
an anchor joint securing said vane to said rung cord at a predetermined point on said rung cord.

22. The Venetian blind of claim 21, further comprising an insert received within an interior of said tube causing said upper surface to be spaced apart from said lower surface.

23. The Venetian blind of claim 22, wherein said insert is generally in a shape of an S.
